(19) United States
(12) Patent Application Publication
(10) Pub. No.: US 2018/0367308 A1
(43) Pub. Date: Dec. 20, 2018

(54) USER AUTHENTICATION IN A DEAD DROP NETWORK DOMAIN

(71) Applicant: LARC Networks, Inc., Los Altos, CA (US)

(72) Inventors: Martin Kacin, Los Altos Hills, CA (US); Gilad Ben-Yoseph, Chicago, IL (US)

(21) Appl. No.: 16/007,748

(22) Filed: Jun. 13, 2018

Related U.S. Application Data
(60) Provisional application No. 62/520,808, filed on Jun. 16, 2017.

(51) Int. Cl. H04L 9/32; H04L 9/08; H04L 29/06

(52) U.S. Cl. CPC H04L 9/3226; H04L 9/0869; H04L 63/083; H04L 9/0894; H04L 9/0819

(57) ABSTRACT

A client device stores domain identification information for authenticating and validating a user on a dead drop domain. The identification information is stored locally on the client device in the form of a domain ID, which includes a cipher comprising an outer core and an inner core. An outer key for decrypting the outer core is stored locally on the client device, or can be generated based on a passphrase that is provided to the client device by the user. The encrypted outer core stores access information for locating and retrieving an inner key from a dead drop on a node of a dead drop domain. The inner key is used by the client device to decrypt the inner core of the cipher. User validation information is stored in the encrypted inner core.

### CROSS-REFERENCE TO RELATED APPLICATIONS

This application claims the benefit of U.S. Provisional Application No. 62/520,808, filed Jun. 16, 2017, which is incorporated by reference herein.

### BACKGROUND

### 1. Field of Art

The present invention generally relates to the field of computer networking and data storage and in particular to a method for authenticating users of a network domain.

### 2. Background of the Invention

The Internet (including the Web) enables users of computers to quickly and easily exchange data. There is a wide range of applications that leverage this ability to exchange data to achieve powerful results for individuals and enterprises alike. Examples include email, file sharing, home automation, entertainment, data management, and more.

However, the way that data is exchanged over the Internet makes the data, and those who send the data, vulnerable to malicious actors. For instance, data moving between parties or stored on a remote server typically include information associated with the sender and the recipient. Accordingly, an interceptor of the data may associate the data with the parties. If the data contain sensitive information, it may leave the parties open to identity theft or other malicious acts. As a result, many users are discouraged from sharing important information via the Internet, thereby missing out on many of the advantages that are afforded to computer users.

### SUMMARY

The above and other needs are addressed by a method, system and computer-readable storage medium for generating a domain identifier (ID) identifying a user to a computerized data storage domain. Embodiments of the method comprise generating an inner key and an outer key for the domain ID and encrypting information about the user using the inner key to produce an encrypted inner core. The method further comprises sending the inner key to the data storage domain, wherein the data storage domain stores the inner key at a location identified by a dead drop identifier (DDID) and receiving, from the data storage domain, the DDID identifying the location at which the inner key is stored. The method additionally comprises generating an outer core comprising the DDID and the inner core, encrypting the outer core using the outer key to produce the domain ID, and storing the domain ID in a non-transitory computer-readable medium.

Embodiments of the system comprise a processor for executing computer program instructions and a non-transitory computer-readable storage medium storing computer program instructions executable by the processor. The computer program instructions are executable to perform steps comprising generating an inner key and an outer key for the domain ID and encrypting information about the user using the inner key to produce an encrypted inner core. The steps further comprise sending the inner key to the data storage domain, wherein the data storage domain stores the inner key at a location identified by a dead drop identifier (DDID) and receiving, from the data storage domain, the DDID identifying the location at which the inner key is stored. The steps additionally comprise generating an outer core comprising the DDID and the inner core, encrypting the outer core using the outer key to produce the domain ID, and storing the domain ID in a non-transitory computer-readable medium.

Embodiments of the computer-readable storage medium store computer program instructions executable by the processor to perform steps comprising generating an inner key and an outer key for the domain ID and encrypting information about the user using the inner key to produce an encrypted inner core. The steps further comprise sending the inner key to the data storage domain, wherein the data storage domain stores the inner key at a location identified by a dead drop identifier (DDID) and receiving, from the data storage domain, the DDID identifying the location at which the inner key is stored. The steps additionally comprise generating an outer core comprising the DDID and the inner core, encrypting the outer core using the outer key to produce the domain ID, and storing the domain ID in a non-transitory computer-readable medium.

### BRIEF DESCRIPTION OF DRAWINGS

FIG. 1 is a high-level block diagram illustrating an example of passing data using a dead drop network architecture according to one embodiment.

FIG. 2 is a high-level block diagram illustrating a detailed view of the dead drop domain of FIG. 1 according to one embodiment.

FIG. 3 is a high-level block diagram illustrating an example of a dead drop storage node according to one embodiment.

FIG. 4 is a flowchart illustrating steps for using a dead drop to pass data from a sender to a recipient according to one embodiment.

FIG. 5 is a high-level block diagram illustrating a technique for authenticating a user in the domain 130 according to one embodiment.

FIG. 6 is a flowchart illustrating steps for generating a domain ID according to one embodiment.

FIG. 7 is a flowchart illustrating steps for authenticating a user using a domain ID according to one embodiment.

FIG. 8 is a high-level block diagram illustrating physical components of a computer used as part or all of one or more of the entities described herein in one embodiment.

### DETAILED DESCRIPTION

The Figures (FIGS.) and the following description describe certain embodiments by way of illustration only. One skilled in the art will readily recognize from the following description that alternative embodiments of the structures and methods illustrated herein may be employed without departing from the principles described herein. Reference will now be made to several embodiments, examples of which are illustrated in the accompanying figures.

It is noted that wherever practicable similar or like reference numbers may be used in the figures and may indicate similar or like functionality. This description occasionally uses reference numbers in combination with letters to designate items illustrated in the figures. Herein, a reference number used without an accompanying letter (e.g., “150”) references any or all instances of the designated item, while a reference number used with an accompanying letter (e.g., “150A”) refers to the specific item designated with that label in the figure.

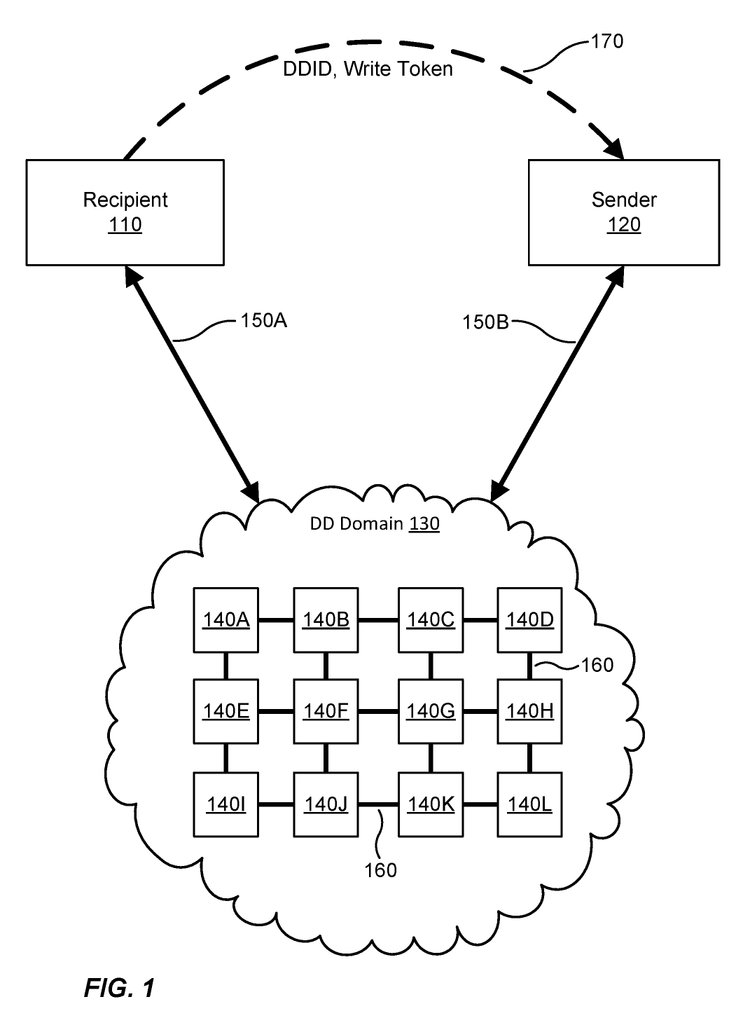

FIG. 1 is a high-level block diagram illustrating an example of passing data using a dead drop network architecture according to one embodiment. FIG. 1 illustrates a recipient 110 in communication with a sender 120 via a dead drop (DD) domain 130. FIG. 1 describes a unidirectional data pass between a single sender 120 and a single recipient 110. Embodiments can have multiple senders 120 and recipients 110 engaged in bidirectional one-to-one and one-to-many communications.

Briefly, the recipient 110 uses the DD domain 130 to establish a communication channel that can be used to pass data to the recipient. The recipient 110 provides the sender 120 with a dead drop identifier (DDID) referencing a storage location within the DD domain. The sender 120, in turn, uses the DDID to pass data (e.g., send a message) to the recipient 110 via the DD domain 130. The data transmission from the sender 120 to the recipient 110 is secure in the sense that it is extremely difficult for a malicious actor or other third party to locate, intercept, or decipher the data. Thus, the DD network architecture is suited to communications where security and privacy concerns are paramount. In addition, the DD network architecture may be used to provide enhanced security for general purpose communications.

In one embodiment, the recipient 110 includes software executing on a computer used by a user (e.g., a person) to perform tasks such as communicating with other users via the DD domain 130 or via other communication networks. For example, the recipient 110 may include software executing on a desktop, notebook, or tablet computer, or another electronic device with computer functionality, such as a mobile telephone, music player, television set-top-box, home automation component, industrial equipment or connected appliance. The recipient 110 may include an input device such as a keyboard or touch-sensitive display that allows for the input of data and an output device such as a display or speaker that allows for the output of data. Functionality enabling the recipient 110 to communicate via the DD domain 130 may be embedded into the hardware of the recipient 110 and/or included in software executed by the recipient 110.

Similarly, the sender 120 includes a computer used by a user to perform tasks including communicating with other users via the DD domain 130 or via other communication networks. The sender 120 may include the same components as the recipient 110. In fact, the sender 120 may act as a recipient 110 and vice versa, depending upon the direction of data flow in a given communication transaction. The users who respectively use the recipient 110 and sender 120 to communicate can be different people or the same person.

The recipient 110 and sender 120 are connected to the DD domain 130 via respective communications links 150A, 150B. The communication links 150 may include network communication links using conventional computer networking technologies. For example, the communications links 150 may use wired or wireless network communications technologies such as the wired and wireless forms of Ethernet. Likewise, the communication links 150 may use other communications technologies designed to support communication with local peripherals, such as Universal Serial Bus (USB), Thunderbolt, Bluetooth, Personal Area Network (PAN), Serial ATA, infrared, heat signatures, and/or sound. The communications links 150 may be encrypted using any encryption technologies such as secure sockets layer (SSL), transport layer security (TLS), HTTP Secure (HTTPS), virtual private networks (VPNs), Internet Protocol security (IPsec), etc. In another embodiment, communication uses custom and/or dedicated data communications technologies instead of, or in addition to, the ones described above.

The DD domain 130 is a collection of one or more DD nodes 140 (labeled as nodes 140A-L in FIG. 1). ADD node 140 includes functionality for acting in the DD domain 130 and a memory for storing data within the domain. A typical DD domain 130 includes many DD nodes 140. Each node 140 is connected to one or more other nodes via DD communication links 160. The DD communication links 160 may use the same communication technologies as the communication links 150 used by the recipient 110 and sender 120 to connect to the DD domain 130. In one embodiment, the DD nodes 140 and DD communication links 160 are arranged within the DD domain 130 such that every node is reachable by every other node. In another embodiment, the DD nodes 140 are logically or physically partitioned so that some nodes cannot reach other nodes. The path connecting two DD nodes 140 may pass through one or more intermediate nodes. In addition, the recipient 150A and sender 150B communication links respectively connect the recipient 110 and the sender 120 to at least one DD node 140 within the DD domain 130. The recipient 110 and sender 120 may also communicate with each other using other communication links that do not pass through the DD domain 130.

To receive data using the DD domain 130, the recipient 110 sends a request to the DD domain 130 to create a DD on behalf of the recipient. ADD node 140 within the domain 130 receives the create request and either services the request or selects another node to service the request. For example, the DD node 140 that receives the request may randomly select another node within the DD domain 130 and pass the request to the selected node. The random selection may occur in a manner such that the node that receives the request does not know which node ultimately services the request.

The node 140 that services the request to create the DD establishes a DDID that uniquely identifies the created DD. In addition, the node 140 establishes a set of tokens associated with the DDID. A token describes the access rights a possessor of the token has with respect to the created DD. For example, an embodiment includes a read token giving a possessor of the token the right to read from the DD identified by the associated DDID and a write token giving the right to write to the DD identified by the associated DDID. The node 140 that services the request provides the DDID and the associated tokens to the recipient 110.

The recipient 110 typically stores the DDID and associated tokens in a secure manner. For example, the recipient 110 may store the DDID and tokens in an encrypted data store at the recipient. The recipient 110 provides the DDID and the write token to the sender 120 via a communications link 170. This communications link 170 may be a secure or unsecure link, and may include communication over the Internet and/or dedicated communications links. For example, the recipient 110 may use encrypted or unencrypted email to send the DDID and write token to the sender 120. Alternatively, the recipient may use a different electronic communications technique, such as short-range wireless communications, or even use non-electronic techniques to exchange the information (e.g., a pen and paper). In one embodiment, the DDID and one or more tokens are combined and may be encrypted or encoded (e.g., by a hashing function) to form a single code. In this embodiment, the recipient 110 may share the code with the sender 120 instead of sharing the DDID and write token separately. The code may be decoded, for example by the sender 120 or at a DD node 140, to determine the DDID and token.

In addition, the recipient 110 and sender 120 may choose to encrypt the data sent by the sender using one or more symmetric or asymmetric encryption techniques. The recipient 110 and sender 120 may choose to exchange encryption keys, if necessary, at the same time the recipient 110 provides the DDID and write token to the sender 120. Alternatively, the recipient 110 and sender 120 may exchange encryption keys at different times, may use encryption techniques that do not require a key exchange, or may choose not to encrypt the data. In one embodiment, the DD domain 130 itself is used to perform the key exchange needed to facilitate an encrypted communications link.

The sender 120 uses the DDID and associated write token to send data to the recipient 110. In one embodiment, the sender 120 sends a write request to the DD domain 130 that includes the DDID and the write token. This request is received by an initial DD node 140 in the DD domain 130. The receiving node 140 determines whether it has the DD identified by the DDID. If not, the receiving node 140 sends a message containing the DDID and the write token to the other nodes within DD domain 130. The node 140 storing the DD associated with the DDID receives the message and verifies the write token. If the token verifies, the node storing the DD creates a connection with the receiving node, which in turn has a connection with the sender 120. The sender 120 then writes the data to the node storing the DD associated with the DDID.

Similarly, the recipient 110 uses the DDID and associated read token to read data from the DD. In one embodiment, the recipient 110 sends a read request to the DD domain 130 that includes the DDID and the read token. This request is received by an initial DD node 140 in the DD domain 130. The receiving node 140 determines whether it has the DD identified by the DDID. If not, the receiving node 140 broadcasts a message containing the DDID and the read token the other nodes within the DD domain 130. The node 140 storing the DD associated with the DDID receives the message and verifies the read token. If the token verifies, the node 140 storing the DD creates a connection with the receiving node, which in turn has a connection with the recipient. The recipient 110 then reads the data from the node storing the DD associated with the DDID.

Thus, the DD network architecture described above permits secure and private communications between the recipient 110 and the sender 120. The sender 120, and/or other parties possessing the DDID and write token can send data to the recipient. However, such parties cannot read the data from the DD. Moreover, a malicious actor who obtains access to one or more nodes 140 in the DD domain 130 may be able to obtain or read data stored in individual DDs. But the malicious actor cannot determine the intended recipients of the data because there is no mapping of DDIDs to recipients. For the same reason, the malicious actor cannot determine the path between a sender and a recipient. In addition, the data stored in the DDs may be encrypted.

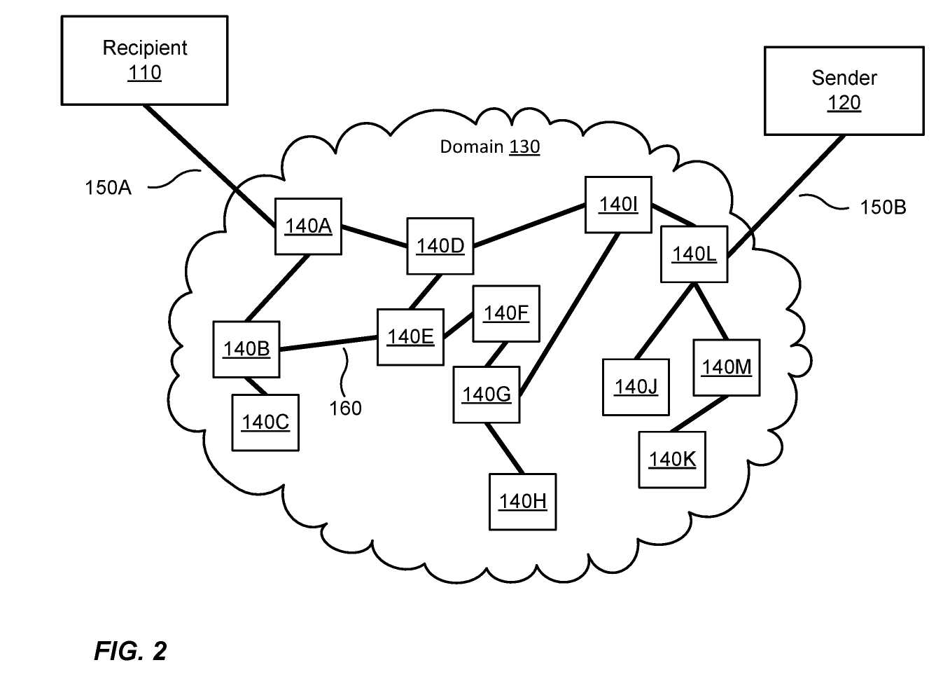

FIG. 2 is a high-level block diagram illustrating a detailed view of the DD domain 130 of FIG. 1 according to one embodiment. As described above, the domain 130 typically includes multiple DD nodes 140 connected by DD communication links 160. The individual nodes 140 within the DD domain 130 may be formed of physically separate computers, such as a collection of geographically disparate computers. In addition, some or all of the nodes may be formed of virtual computers. For example, the nodes 140 of a domain 130 may be instances of virtual computers hosted in a cloud environment.

Each DD node 140 has an associated set of characteristics that describe attributes of the node. The characteristics may describe the location of the node 140. The location may be specified as a geographic location. In addition, the location may be specified as a logical location (e.g., a “zone”). For example, the logical location may indicate that the node is associated with a particular enterprise (e.g., a business) or other group. The characteristics may also describe physical properties of the node, such as a node's processing power, storage capacity, uptime, and the like.

In one embodiment, the set of DD nodes 140 in a DD domain 130 may be divided into multiple subdomains, with each subdomain including a proper subset of nodes from the set of DD nodes in the DD domain. The subdomains to which a node 140 is member may be determined based on the characteristics of the node. For example, the DD domain 130 may include nodes 140 distributed over a wide geographic area (e.g., a country), and a subdomain may include nodes physically located within a smaller area (e.g., a state within the country). Similarly, the DD domain 130 may include nodes 140 associated with multiple enterprises, and a subdomain may include only nodes associated with one of the enterprises or a part of an enterprise.

In one embodiment, the DD nodes 140 are arranged as a mesh network. Each node 140 is connected to at least one other node via a DD communication link 160. Moreover, each node 140 maintains a routing table identifying the nodes to which it is connected. A node 140 can send a message to another node by forwarding the message to the nodes to which it is connected. The nodes 140 that receive the message in turn forward the message to other nodes, until the message reaches the node to which it is directed. The path followed by the message is formed of hops from node 140 to node along the DD communication links 160.

Consider the communications between the sender 120 and the recipient 110 described in FIG. 1 in the context of FIG. 2. As shown in FIG. 2, the recipient 110 is connected to a node 140A of the domain 130 via a communication link 150A. This node 140A serves as the point of ingress to the domain 130 for the recipient. The recipient 110 sends a request to the ingress node 140A of the domain 130 to create a DD on behalf of the recipient. This request may include domain information specifying a particular subdomain in which the DD should be created. For example, the domain information may specify that the DD should be created in a node 140 located in a particular geographic area or managed by a particular enterprise.

The node 140A serving as the point of ingress for the recipient 110 receives the create request and analyzes the domain information to identify the subdomain in which the DD should be created. In one embodiment, the node 140A services the request by randomly selecting a node within the specified subdomain that will host the DD. In one embodiment, random selection is performed using a load balancing technique, which may be performed by the node 140A or by a separate computing device. In one embodiment, the node 140 services the request by randomly selecting a number of node hops for which the request will be forwarded, and randomly selecting another node within the specified subdomain to which the node 140A is connected. The ingress node 140A then forwards the request to the randomly selected node (e.g., node 140D) and also forwards the selected value for the number of node hops. The node 140D to which the request was forwarded randomly selects another node (e.g., node 140E) in the subdomain from its routing table, decrements the value for the number of node hops, and forwards the request to the selected node. This selection, decrement, and forward process repeats until the value for the number of node hops reaches zero, at which point the final node establishes and hosts the DD associated with the request from the recipient 110. In one embodiment, each node that forwards the create request includes the path from the ingress node 150A to the forwarding node with the request. The final node that creates the DD uses the path to identify and contact the ingress node 140A for the recipient 110. For example, the node 140 may use the path to send the DDID and associated tokens to the ingress node 140A, so that the latter node can provide this information to the recipient.

For example, assume the ingress node 140A receives a create request from the recipient 110, and also assume that the request specifies a subdomain encompassing nodes 140A, 140D and 140E, as well as other nodes within the domain 130. Also assume the ingress node 140A randomly selects “2” as the number of hops. The ingress node randomly selects a node (e.g., node 140D) from the specified subdomain in its routing table, decrements the hop value, and forwards the request and decremented hop value (e.g., “1”) to the selected node. That node 140D, in turn, randomly selects another node (e.g., node 140E), decrements the hop value, and forwards the request and decremented hop value (e.g., “0”) to the selected node. The final node 140E evaluates the hop value and determines that it is “0” and, therefore, creates the DD and associated tokens. The final node 140E then returns the DDID and tokens to the ingress node 140A via the reverse of the path used to reach the final node.

Variations on the techniques described above may be used in some embodiments. In one embodiment, a node forwarding a request decrements the hop value only if the node is within the specified subdomain. This variation may be used, for example, in situations in which a node receiving a create request is not within the specified subdomain and/or connected to any other nodes in the subdomain. In this situation, the nodes may randomly forward the request to other nodes until a node within the specified subdomain receives the request, at which point the node in the subdomain decrements the hop value and forwards the request anew if the hop value is greater than zero or creates the DD and associated tokens if the hop value is zero.

The sender 120, in turn, is connected to a different node 140L that serves as the point of ingress for the sender to the domain 130 via a different communication link 150B. When the sender 120 makes a write request, the sender provides the DDID and write token to the sender's ingress node 140L. This node 140L forwards the request including the DDID and write token to the other nodes in its routing table, and the other nodes continue to forward the request until it reaches the node having the DD associated with the DDID (e.g., node 140E). This node 140E verifies the token and establishes a connection with the sender's ingress node 140L using a return path created by the forwarding nodes. Alternatively, the node 140E may establish a direct connection with the sender 120. The sender 120 provides the data to be written to the ingress node 140L, and that node forwards the data to the node 140E having the DD via the connection. A read request made by the recipient 110 is handled in a similar fashion in one embodiment, except that the recipient reads data from, rather than writes data to, the node 140E having the DD.

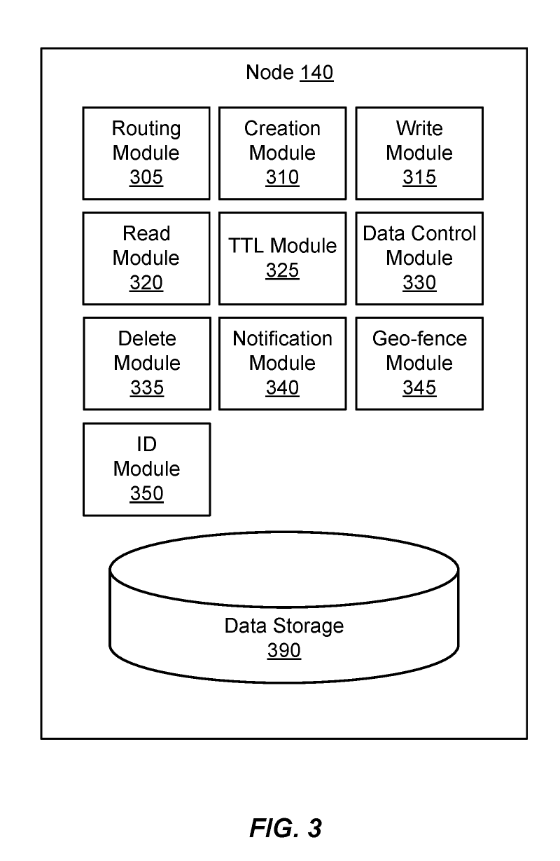

FIG. 3 is a high-level block diagram illustrating an example of a DD node 140 according to one embodiment. The node 140 includes a routing module 305, creation module 310, write module 315, read module 320, time-to-live (TTL) module 325, data control module 330, delete module 335, notification module 340, geo-fence module 345, identifier (ID) module 350, and data storage 390. Other embodiments may include different or other modules in other embodiments. In addition, the behaviors of the modules may differ in other embodiments.

Turning now to the individual modules within the node 140, the routing module 305 routes messages received by node 140. As part of this task, an embodiment of the routing module 305 maintains the routing table for the node 140. The routing module 305 periodically communicates with other nodes 140 to which it is connected to ascertain information about those nodes. This information may include, for example, network addresses of the nodes, information about the subdomains with which the nodes 140 are associated, and the like. The routing module 305 stores this information about the connected nodes in the routing table. In addition, the routing module 305 responds to routing table-related communications from routing modules 305 of other nodes 140.

The messages handled by the routing module 305 include messages related to create requests, write requests, read requests, and other types of messages and requests described herein. For a given message, the routing module 305 analyzes the message to determine whether to process the message locally on the node 140 or to route the message to another node in the routing table. For example, upon receiving a create request from another node, the routing module 305 examines the hop value to determine whether it is greater than zero. If the hop value is greater than zero, the routing module 305 decrements the hop value, randomly selects a connected node in the routing table (subject to any specified subdomain constraints, if applicable), and forwards the request and decremented hop value to the selected node. If the hop value is zero, the routing module 305 provides the request to the creation module 310.

Similarly, upon receiving a write request, the routing module 305 determines whether the DDID is associated with a DD maintained by the node 140. If the DDID is not associated with a DD maintained by the node 140, the routing module 305 forwards the request to other nodes in its routing table. If, on the other hand, the DDID is associated with a DD maintained by the node, the routing module 305 provides the request to the write module 315. The routing module 305 handles read requests, as well as other requests described herein, in the same fashion.

The creation module 310 creates DDs in response to requests received by the node 140. Upon receiving a create request from the routing module 305, the creation module 310 generates a DDID to represent the DD for the request. In addition, the creation module 310 generates a set of tokens associated with the DDID. The creation module 310 provides the DDID and tokens to the recipient 110 that requested the DD using the path to the recipient's ingress node 140A as described with respect to FIGS. 1 and 2.

In one embodiment, the creation module 310 generates the DDID as a globally unique identifier (GUID). The DDID is a value represented using a large number of bits (e.g., a 128-bit value). A small portion of the bits may be fixed to identify the value as a DDID or encode other information, while the other bits are randomly generated by the creation module 310. The large number of bits makes it extremely unlikely that the same DDID would be generated for multiple DDs. Therefore, each DDID is unique for practical purposes. The DDID may be represented as sequence of hexadecimal digits.

In one embodiment, the tokens generated by the creation module 310 may include a write token, a read token, and an owner token. The write and read tokens respectively provide the bearer of the token the rights to write data to, and read data from, the DD associated with the DDID as described above. The owner token provides the bearer with administrative rights to the DD, such as the right to delete data within the DD or delete the entire DD.

In one embodiment, a token, like the DDID, is a value represented using a large number of bits, some of which may be fixed and others of which are randomly generated by the creation module 310. The number of bits in each token may be fewer than the number of bits in the DDID. Each token associated with a particular DDID is unique with respect to other tokens associated with that DDID.

The creation module 310 allocates space in the data storage 390 for the created DD and associates this space with the DDID. The amount of space, and the time when the space is allocated may vary in different embodiments. In one embodiment the creation module 310 allocates a fixed amount of storage space for the DD when creating the DD. In another embodiment, the creation module 310 allocates the storage space later, when receiving data to store in the DD. Likewise, the amount of space allocated for the DD can vary in different embodiments.

The write module 315 writes data to DDs in response to write requests received by the node 140. Upon receiving a write request from the routing module 305, the write module 315 initially verifies the write token included in the request. The write module 315 identifies the DDID and write token included in the request, and compares the write token to the stored write token created by the creation module 310 for the DDID. If the compared write tokens do not match, the write module 315 denies the write request. Depending upon the embodiment, the write module 315 can deny the request by acting as if the request was not received (i.e., by not sending any messages in response to the write request) or by sending a message to the sender 120 indicating that the write token is invalid.

If the compared write tokens match, the write module 315 uses the return path in the write request to open a network connection with the ingress node 140L for the sender 120. The write module 315 receives data from the sender of the write request, and writes the data to the storage allocated for the DD identified by the DDID. In one embodiment, the write module 315 stores the data in a DD as a series of discrete messages, such that the data for each write request to a DD is saved as a logically separate message. The stored messages for the DD are organized in a queue or another data structure.

The read module 320 reads data from DDs in response to read requests received by the node 140. Upon receiving a read request from the routing module 305, the read module 320 initially verifies the read token included in the request. The read module 320 identifies the DDID and read token included in the request, and compares the read token to the stored read token created by the creation module 310 for the DDID. If the compared read tokens do not match, the read module 320 denies the read request. Like the write module 315, the read module 320 can deny the request by acting as if the request was not received (i.e., by not sending any messages in response to the read request) or by sending a message to the recipient 110 indicating that the read token is invalid.

If the compared read tokens match, the read module 320 uses the return path in the read request to open a network connection with the ingress node 140A for the recipient 110. The read module 320 reads data from the storage allocated for the DD, and sends the data to the recipient 110 via the ingress node 140A. In another embodiment, a direct connection is established between the node storing the DD and the recipient 110 and the data is sent to the recipient without passing through the ingress node 140A. If the data in the storage is organized in a queue, an embodiment of the read module 320 sends the message in the queue in response to the request (e.g., in a first-in-first-out order) and removes the message from the queue after it is sent. Other embodiments may send multiple messages per read request and/or leave message in the queue after the messages are sent to the recipient 110. In another embodiment, the contents of a DD are not read, for example, because the holder of a read token corresponding to the DD no longer wishes to communicate with the sender of the message. In this case, communication may be disconnected unilaterally by the recipient, without action, consent, or knowledge by the sender.

The TTL module 325 maintains TTL information for the node 140. The TTL information generally describes for how long an entity persists in the domain 130. For example, DDs, DDIDs, tokens, and data written to DDs may have associated TTL information that describes how long the respective entities persist within the domain 130. Once the duration described by the TTL is reached, the entity to which the TTL pertains expires, is no longer recognized as valid, and may be deleted.

In addition, the TTL module 325 enforces the TTLs by detecting when a duration described by a TTL is reached, and invalidating the entity associated with the TTL. For example, if the TTL module 325 detects that a TTL for a DD is reached, the TTL module deletes the data stored within the DD and also deletes or otherwise invalidates the DDID and tokens associated with the DD so that the DD can no longer be accessed. Similarly, if the TTL module 325 detects that a TTL for data written to a DD is reached, the TTL module 325 deletes the data from the DD so the data can no longer be read.

The TTL information may be specified as a counter (e.g., a duration of time from the present time) or as a timestamp (e.g., an explicit time after which the entity is no longer valid). Additionally, the TTL may be specified as a number of instances of particular types of access (e.g., a DD expires once it is read from 3 times, or written to once). Further, the TTL information may be specified as a category (e.g., “default,” “short,” “medium,” “long,” or “confidential”). In the latter case, the TTL module 325 converts the category description to a counter or timestamp based on a TTL policy. Different entities may have different applicable TTL policies. For example, the TTL policies may specify that the “default” TTL for a DD is 30 days and the “default” TTL for a message is 7 days. The TTL module 325 may also support an “archive” TTL that does not expire, therefore making the entity having the TTL persistent.

In one embodiment, the recipient 110 specifies the TTL for a DD when creating it. For example, the TTL information may be embedded into the create request. Likewise, the sender 120 may specify the TTL for data by embedding the TTL in the write request. For example, the recipient 110 may specify a specific amount of time or number of instances of access for which the DD is valid, or specify a category as discussed above. The TTL specified for the DD is embedded into the create request and received by the TTL module 325.

The data control module 330 supports management of DDs for the nodes 140 of the domain 130. The data control module 330 provides a variety of management functions that can be accessed by the recipient 110 or other entity making a request for a particular function and providing tokens granting administrative authority, reading privilege, writing privilege, etc. for a given DD.

In one embodiment, the data control module 330 provides a movement function that moves a DD from one node 140 to another node while maintaining the same DDID. The recipient 110 may issue a move request that contains the DDID, the owner token and, optionally, a specification of a node to which the DD should be moved. In various embodiments, movement of a DD may be initiated by a user request, environmental factors (e.g., a node 140 is scheduled to be taken offline, time of day), or a policy definition (e.g., a DD may only stay on a specific node 140 for a certain time before it is required to be moved). The node 140 to which the DD should be moved may be specified, for example, by indicating a subdomain to which the DD should be moved. In response to a move request having a valid owner token, the data control module 330 of the node 140 having the DD identified by the DDID identifies a new node to which the DD is to be moved. For example, the data control module 330 may randomly select a new node within the specified subdomain using the random selection technique described above and send that node a message identifying the DDID and the data for maintaining in the DD identified by the DDID. A data control module 330 in the new node 140 establishes a new DD under the existing DDID, and stores the received data in that DD. Once the new DD is established, the data control module 330 may optionally delete the DD identified by the DDID so that the DD has effectively been moved to the new node.

The data control module 330 also provides a replicate function that replicates a DD from a node 140 to one or more other nodes. The replication is similar to the movement function, except that the original data control module 330 does not delete the DD identified by the DDID after the new DD is created. In one embodiment, replication is initiated by a recipient 110. In another embodiment, replication is initiated automatically (e.g., by executable instructions stored in the DD that specify rules for replication). When a node 140 containing a replicated DD fulfills a write request, the routing module 305 forwards the write request to other nodes in the routing table so that each instance of the replicated DD may fulfill the write request and maintain data currency.

The data control module 330 further provides an archive function that stores an archive of a DD in another node 140. To perform the archive, the data control module 330 of the node 140 storing the DD receives an archive request similar to the move request. The data control module 330 communicates with the data control module 330 of the new node 140 to create a new DD associated with the same DDID. The data control module 330 sets the TTL for the entities associated with the new DD as “persistent,” meaning that the new DD acts as an archive for the DD in the original node. The data control module 130 of the original node 130 may optionally delete the DD identified by the DDID after the archive is created.

The delete module 335 deletes DDs from a node 140. The delete module 335 receives a delete request from the recipient 110 or another entity. The delete request contains a DDID and the associated owner token. The delete module 335 verifies that the received token grants delete privileges and, if it does, deletes the DD identified by the DDID from the node 140. In another embodiment, delete module 335 may delete one or more messages stored in a DD and not the entire DD itself. In one embodiment, the delete module 335 writes data to the storage location from which the DD is deleted. This writeover data may be randomly generated or predetermined. Writing writeover data makes recovering deleted data more difficult. It also makes finding DD data more difficult by increasing the total amount of stored data in the storage location, with the multiple instances of writeover data obfuscating DD data.

A notification module 340 provides notifications to recipients 110 regarding changes to DDs. In one embodiment, the notification module 340 of a node 140 receives a notification request from a recipient 110 or another entity. The notification request 110 includes the DDID of the node for which the notification is to be created and a token (e.g., owner token, read token) associated with the DDID. The notification request may also indicate the types of events (i.e., changes to the DD) for which notifications are requested. For example, the notification request may specify that notifications are to be made for only writes to a DD. The notification request further includes a notification address to which a notification is to be made when there is a change to the identified DD. In another embodiment, the notification address may be specified in the form of a DDID and write token for a different DD in the domain 130. The notification address may also be specified as a different form of address, such as an address on the Internet to which an email or another form of message may be sent.

If the token for a DDID in a notification request is correct, the notification module 340 examines the notification request to identify the type of event for which the notification is requested. The notification module 340 then creates a notification for the event. In one embodiment, the notification module 340 establishes a trigger that detects when the appropriate type of event occurs for the identified DD. To this end, the notification module 340 may monitor the activities of the other modules (e.g., the write module 315) to determine when such events occur. For example, if the notification request specifies a write event, the notification module 340 may monitor the write module 315 to detect writes to the indicated DD.

When the requested event is detected, the notification module 340 generates and sends a notification to the specified notification address. The notification may identify the DD to which the event occurs (e.g., by including the DDID in the notification) and the type of event that occurred (e.g., a write to the DD having the DDID). If the notification address is for a DD, the notification module 340 acts as a sender 120 and uses the write token and DDID specified in the notification request to write the notification to the DD. In this example, the recipient 110 or other entity that requested the notification can monitor a single DD to receive notifications about events occurring in multiple different DDs. If the notification address is specified as a different form of address, the notification module 340 sends the notification using the appropriate technique for the address.

A geo-fence module 345 receives and analyzes geographic-related restrictions associated with the DD or requests received by the DD. The geo-fence module 345 communicates with the other modules in the DD to enforce such restrictions. The restrictions may specify that a DD is only accessible by senders and recipients within a geographic area specified by the creator of the DD. Access may be restricted in various ways in different embodiments. For example, in one embodiment, requests received by a DD may be valid only if the originator of the request is located within a certain geographic area. In another embodiment, a DD or specific contents of the DD may be accessible only if a specified party (e.g., owner, recipient, sender, third party, etc.) is within a certain geographic area. The geo-fence module 345 may also communicate with the notification module 340 to send notifications when events (e.g., write requests, read requests, etc.) occur within specified geographic areas.

The ID module 350 provides services for generating, maintaining, and revoking domain IDs associated with users of the domain 130. The ID module 350 communicates with the other modules in the DD to provide the domain-ID related services. Generally, these services include issuing unique domain IDs to users of the domain 130 and obtaining DDIDs and associated tokens, and further associating the DDIDs and tokens with the respective users. In addition, the ID module 350 may revoke or otherwise invalidate domain IDs at appropriate times, such as when a user leaves the domain 130 or when a token is potentially compromised. Likewise, the ID module 350 may facilitate the storing of keys associated with domain IDs within the domain 130.

In one embodiment, the domain ID module 350 maintains user activation records for users of the domain. The user activation records store validity information indicating whether particular domain IDs are valid (e.g., whether a cipher is associated with a legitimate and current user account). Specifically, a user activation record holds one or more values indicating whether a given domain ID is valid, such as a binary validity flag. A user activation record may be accessed when a user uses a domain ID to access the domain 130, such as at the start of a user session. If the validity information in the associated user activation record indicates that the domain ID is valid, the possessor of the domain ID is permitted to access the domain 130. Otherwise, the possessor of the domain ID is denied access. The validity information in the user activation records may be changed by a system administrator of the domain 130, for example to grant or deny a user access to the domain 130.

In one embodiment, the domain ID module 350 stores the user activation records at DDs in the domain 130. For example, each record may be maintained at a separate DD identified by a unique DDID. Thus, each activation record can be accessed by using its associated DDID. In another example, the domain ID module 350 may maintain a database of user activation records at a DD in the domain 130, where the database is identified by a unique DDID. In this latter example, a given activation record may be accessing through use of the DDID for the database plus additional information describing the location of the record within the database.

The data storage 390 stores data used by the node 140. The data may include data being maintained in DDs managed by the node 140, DDIDs and tokens associated with the DDs, and information used by the modules within the node 140 to perform the tasks described herein. Depending upon the embodiment, the data storage 390 may include one or more types of non-transitory computer-readable persistent storage media. For example, the data storage 390 may include a hard drive, solid-state memory device, and/or other form of persistent memory.

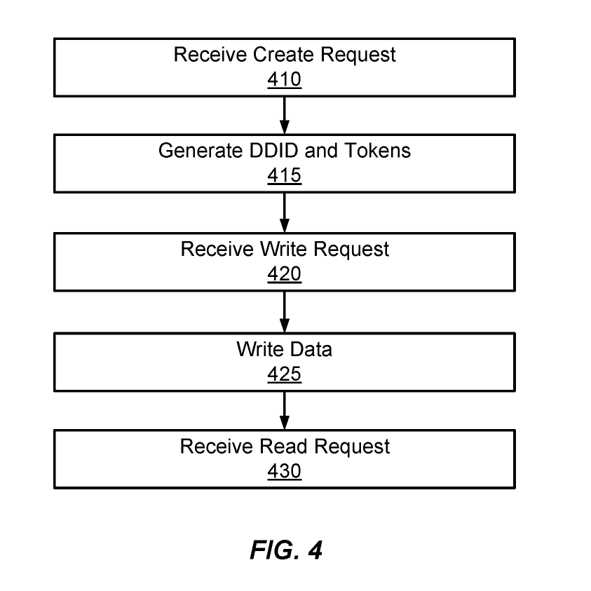

FIG. 4 is a flowchart illustrating steps for using a DD to pass data from a sender 120 to a recipient 110 according to one embodiment. FIG. 4 describes the steps from the perspective of a node 140 of a domain 130. Other embodiments may include different and/or other steps than those described herein, and the steps may be performed in different orders. Likewise, some or all of the steps may be performed by entities other than the node 140 in other embodiments.

The node 140 receives 410 a create request. As described above, a recipient 110 can issue the create request and send the request to an ingress node 140A in the domain 130. The ingress node 140A randomly selects a node to service the request. Assume, then, that the node 140 receives 410 the create request after having been randomly selected to service it. In response to the create request, the node 140 generates 415 a DDID and a set of associated tokens for the new DD. In addition, the node 140 may allocate storage space for storing data written to the DD. The node 140 provides the tokens and DDID to the recipient 110.

Subsequently, the node 140 receives 420 a write request including the DDID and associated write token. The write request may have been issued by a sender 120 who received the DDID and write token from the recipient 110. The sender 120 sends the write request to an ingress node 140L in the domain 130 which, in turn, forwards the write request to other nodes in the domain until it reaches the node that created the DD associated with the DDID. The node 140 determines whether the write token is valid. If the token is valid, the node 140 responds to the write request by establishing a connection with the sender's ingress node 140L. The node 140 receives the data to be written to the DD from the sender 120 via the ingress node 140L and stores 425 the data in the DD. If the token is not valid, an embodiment of the node 140 does not respond to the write request.

The node 140 later receives 430 a read request including the DDID and associated read token. The read request may have been issued by the recipient 110 who established the DD identified by the DDID. Similar to a write request, the recipient 110 sends the read request to an ingress node 140A in the domain 130 which forwards the read request to other nodes in the domain until it reaches the node that created the DD associated with the DDID. Upon receiving the read request, the node 140 determines whether the read token is valid. If the token is valid, the node 140 responds to the read request by establishing a connection with the recipient's ingress node 140A and sends it the data from the DD. For example, if the DD is maintained as a queue, the node 140 will send the data that is next in the queue.

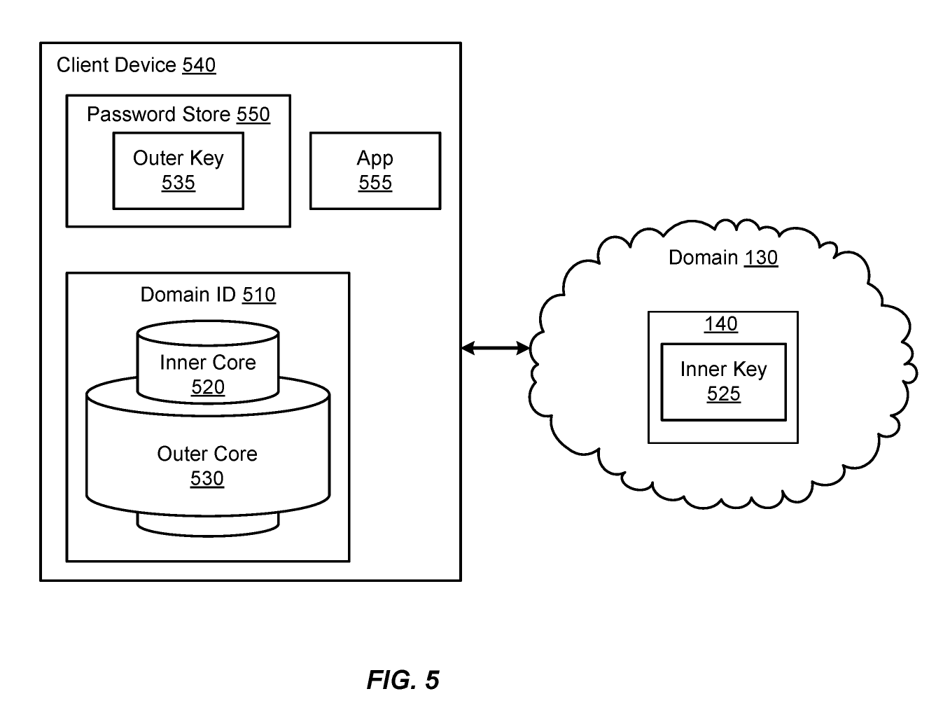

FIG. 5 is a high-level block diagram illustrating a technique for authenticating a user in the domain 130 according to one embodiment. FIG. 5 shows interactions between a client device 540 and a node 140 of the domain 130 involving use of a domain ID 510. In one embodiment, the client device 540 is a computer having software executing thereon to access data stored in the domain 130 and perform other functions with respect to the domain. For example, the computers described in association with the recipient 110 and sender 120 above are examples of client devices 540. In another embodiment, the client device 540 includes a non-transitory computer-readable storage medium storing data than can be accessed by a computer having software executing thereon to access data stored in the domain 130 and perform other functions with respect to the domain. For example, the client device 540 may be a portable storage device such as a universal serial bus (USB) memory stick or hard drive. The client device 540 may also be a cloud-based data storage.

The user of the client device 540 is an entity that avails itself of the resources of the domain 130, such as by acting as a recipient 110 and/or sender 120. The user may be a person and this disclosure generally refers to the user as a person. The user may also be another entity, such as an enterprise (e.g., corporation, government agency, educational institution), an internet of things (IoT) device, content, an inanimate object, or a pet.

A domain ID 510 is associated with a user and identifies and authenticates the user to the domain 130. That is, the domain ID 510 represents the identity of the user within the domain 130. The domain ID 510 provides a basis from which privileges for the user are determined. Such privileges may include publishing information to the domain 130, specifying access privileges of other users with respect to published information, and accessing information published by other users. Thus, a user who accesses the domain 130 may have limited privileges if the user does not provide a domain ID 510. For example, a domain ID 510 may allow a user to publish information such as a user profile to a public location of the domain 130. In some embodiments, a user without a domain ID 510 may not be allowed to publish any content to the domain 130.

A domain ID 510 is held by the user with which the domain ID is associated. The domain ID 510 is not stored at a central server or elsewhere on the domain 130. Specifically, in an embodiment the domain ID 510 is stored on the client device 540 as illustrated in FIG. 5. Thus, it is the user who provides the domain ID 510 to attest to the user's identity, not a server or other centralized entity or authority.

In one embodiment, the domain ID 510 includes a cipher with an inner core 520 and an outer core 530. The information on the inner core 520 can be used to validate the identity of a user possessing the domain ID 510. The inner core 520 contains information identifying and authenticating the user to the domain 130. This information may include a unique user name of the user and a set of DDIDs (i.e., GUIDs) associated with the user. The information in the inner core may also include tokens granting certain rights to the user. In one embodiment, the inner core 520 additionally includes information forming an audit trail for the user, for example, data about when the domain ID 510 was issued to the user and how the domain ID has been used by the user.

In one embodiment, information on the inner core 520 includes data that is related to an activation record associated with the user. An activation record may be generated when a user account is created for the domain 130 and maintains information about whether a user's account is valid and current. The data in the inner core 520 includes a reference to the node 140 or other location in the domain 130 at which the user's activation record can be accessed, such as a DDID and/or other information.

The information on the inner core 520 is encrypted with a randomly-generated symmetric key, referred to herein as an inner key 525. An inner key 525 is unique to the user. Thus, each domain ID 510 has an inner core 520 encrypted using a different inner key 525. In one embodiment, the inner key 525 is stored in the domain 130 (e.g., within a dead drop on a node 140). As with other nodes 140 in the domain 130, the location of a node 140 storing an inner key 525 is identified with a DDID. Thus, the DDID of the location in the domain 130 storing the inner key is needed in order to access (i.e., decrypt) the information in the inner core 520.

The inner core 520 of the domain ID 510 is wrapped by an outer core 530. In one embodiment, the wrapping is performed by appending additional information to the encrypted inner core 520. The outer core 530 therefore includes the encrypted inner core 520 plus the additional information. In one embodiment, the additional information includes the DDID that identifies the location of the inner key 525 in the domain 130. The outer core 530 itself is encrypted using an outer key 535. The outer key 535 is a symmetric key generated based on a user-provided passphrase, such as a sentence or other alphanumeric string provided by the user. The user-provided passphrase serves as the seed to generate the symmetric outer key 535. In other embodiments, the outer key 535 is asymmetric and/or generated through the use of other techniques.

The outer key 535 is stored securely on a client device 540. In one embodiment, the outer key 535 is stored using a secure password store 550. The secure password store 550 securely stores the outer key 535 and makes the outer key 535 available for use on the client device 540 only if the user successfully authenticates to the client device 540. For example, the secure password store 550 may make the outer key 535 available only if the user provides an appropriate credential such as a password or biometric feature. The secure password store 550 may utilize functionality provided by the client device 540, such as functionality provided by an application executing in tandem with specialized security hardware on the device. The secure password store 550 may store the outer key 535 within the client device 540 and/or within a secure cloud storage environment. In one embodiment, the functionality of the secure password store 550 is provided by the KEYCHAIN password management system provided by APPLE, INC. The secure password store 550 functionality may be provided by other systems, software, or hardware in other embodiments.

In one embodiment a user uses a domain-affiliated application 555 to interact with the domain 130. The application 555 executes on the client device 540 and provides functionality allowing the user to establish a domain ID 510, publish content to the domain 130, and access content published by other users. To establish a domain ID 510, the user interacts with the application 555 to provide information used by the domain 130 to identify and authenticate the user. This information may include a user ID, the passphrase used as the seed for the outer key 535, and payment information. The application 555 interacts with the domain 130, e.g., an ID module 350 on a node 140 of the domain 130, to create a domain ID 510 and associate it with the user. As part of this process, the application 555 creates and encrypts the inner core, stores the inner key 525 in the domain 130, creates and encrypts the outer core 530, and stores the outer key 535 in the password store 550. The application 555 may perform the creation and encryption processes in a secure memory of the client device 540 to prevent eavesdropping and/or tampering.

To authenticate the user to the domain 130, the application 555 interacts with the password store 550 to receive the outer key 535. As part of this process, the user may provide a password or other authentication credentials to the client device 540, password store 550, and/or application 555 to cause the password store 550 to release the outer key 535 to the application. The application 555 uses the outer key 535 to decrypt the outer core 530 and obtain the DDID identifying the location of the inner key 525 in the domain 130. The application 555 uses this DDID to obtain the inner key 525 from the domain 130 and then uses the inner key 525 to decrypt the inner core 520. The application 555 uses the information in the inner core 520 to authenticate the user to the domain 130 and check whether the user's domain ID is valid. The application 555 may hold the keys and perform the decryptions in the secure memory of the client device 540 to prevent eavesdropping and/or tampering. In addition, the application deletes the keys and decrypted cores from the memory once the access to these data are no longer required.

A domain ID 510 may become invalid. For example, the domain ID 510 may have a predetermined invalidity period (e.g., one year) or may invalidate upon the occurrence of a specified event (e.g., non-payment of a fee by the user, a security violation at the client device 540, an explicit invalidation request from the user). In one embodiment, the application 555 executes to invalidate the domain ID 510. The application 555 sends a message to the ID module 350 requesting that the ID module 350 invalidate the domain ID 510. The ID module 350 may then invalidate the ID by changing the validity information in the activation record for the domain ID to indicate that the ID is invalid.

In addition, or alternatively, the ID module 350 may interact with the TTL module 325 to cause the TTL for the location in the domain 130 storing the inner key 525 to expire. The TTL module 325 may also expire other locations in the domain 130 holding DDIDs used to access the location storing the inner key 525. This action effectively renders the inner key 525 inaccessible, as the inner key 525 can no longer be retrieved using the associated DDID. As a result, the application 555 can no longer decrypt the inner core 520 and can no longer use the information contained therein to authenticate the user to the domain 130. The domain ID 510 may also be invalidated without action by the application 555, such as upon expiration of the predetermined validity period. In this case the ID module 350 and/or TTL module 325 may change the validity information in the activation record and/or expire one or more locations in the domain 130 to render the inner key 525 inaccessible.

In one embodiment, when the client device 540 decrypts the inner core 520 as part of the process of starting a session involving the domain 130, software on the client device 540 obtains the DDID associated with an activation record from the decrypted information from the inner core 520. The DDID is used to obtain the activation record from the domain 130. The client device 540 software checks a value associated with the activation record to determine whether the domain ID 510 is valid and, therefore, whether the user is a current authorized user of the domain 130. In another embodiment, the validity check is performed within the domain 130 (e.g., by the ID module 350) and the client device software receives one or more values indicating the result of the check. The software on the client device 540 may accordingly block or allow access to the domain 130.

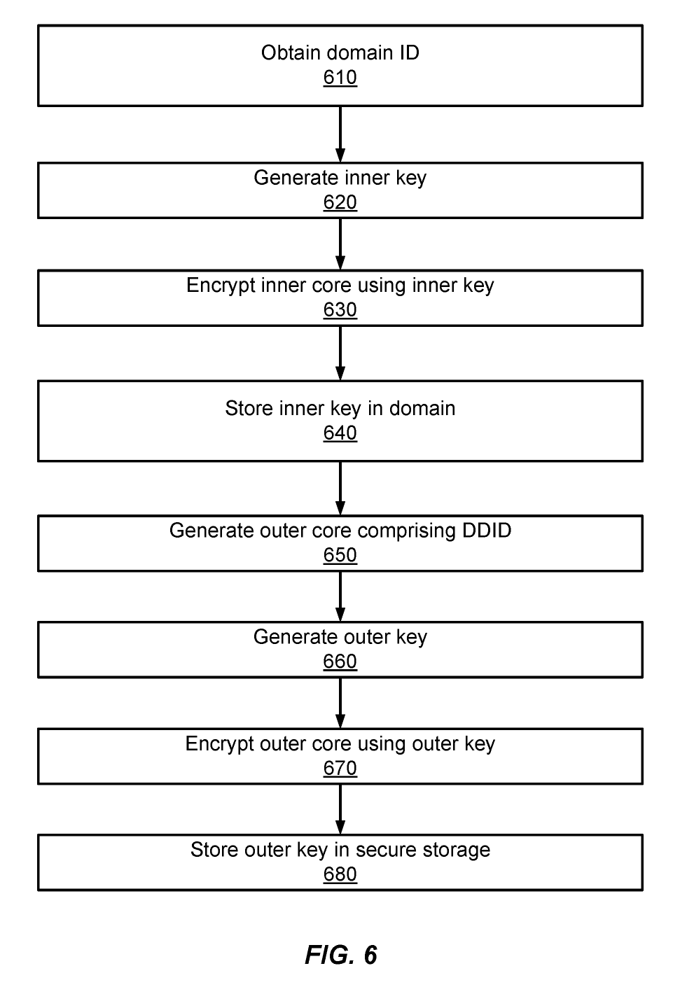

FIG. 6 is a flowchart illustrating steps for generating a domain ID 510 according to one example embodiment. A user accesses a client device 540, such as a phone, tablet, computer, or other device that can access the domain 130. The user executes an application 555 that is affiliated with the domain 130 on the client device 540 and obtains 610 a domain ID 510. User information for identification and authentication is collected by the client device 540 and/or received from the domain 130.

The domain-affiliated application 555 randomly generates 620 an inner key 525 or receives the inner key 525 from the domain 130. The domain-affiliated application 555 encrypts 630 the user information, including the DDID for the associated activation record, using the inner key 525 to form the inner core 520. The domain-affiliated application 555 stores 640 the inner key 525 at a node 140 in the domain 130. In storing the inner key 525, the domain-affiliated application 555 receives a DDID identifying the location at which the inner key 525 is stored.

The domain-affiliated application 555 generates 650 an outer core 530 comprising the DDID associated with the inner key 525 and encrypted inner core 520. An outer key 535 is generated 660 from a user-provided passphrase and the domain-affiliated application 555 encrypts 670 the outer core 530 using the outer key 535. The domain-affiliated application 555 stores 680 the outer key 535 in a secure location on the client device 540, for example, in a password store 550. In an alternative embodiment, the application 555 stores the passphrase (and/or a hash or other representation of the passphrase) that can be used to generate the outer key 535, rather than storing the outer key 535.

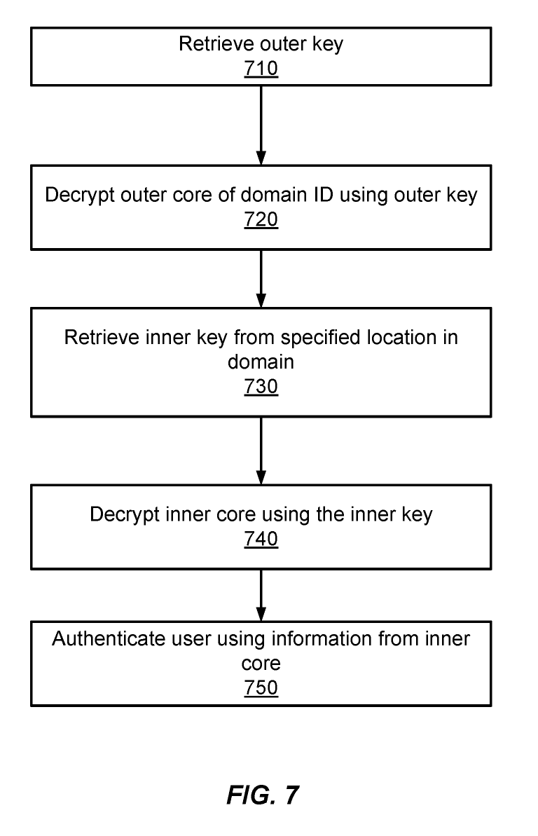

FIG. 7 is a flowchart illustrating steps for authenticating a user using a domain ID 510 according to one embodiment. The domain-affiliated application 555 retrieves 710 an outer key 535 for the domain ID 510 by, e.g., receiving the outer key from a password store 550 on the client device 540 generating it using a passphrase received from the user. The domain-affiliated application 555 decrypts 720 an outer core 530 of a domain ID 510 using the outer key 535. The decrypted outer core 530 yields a DDID specifying a location of an inner key 525 for the domain ID 510 on the domain 130. The domain-affiliated application 555 retrieves 730 the inner key 525 from the location on the domain 130. Using the inner key 525, the domain-affiliated application 555 decrypts 740 an inner core 520 of the domain ID 520. The decrypted information from the inner core 525 includes user information. The domain-affiliated application 555 uses 750 the user information to authenticate the user to the domain 130. In one embodiment, the decrypted information from the inner core 525 includes a DDID for accessing an activation record of the user in the domain 130. The client device 540 accesses the activation record on the domain 130 to determine whether the domain ID is valid. If the activation record indicates the domain ID is valid, then the user is authenticated and permitted to access the domain 130. Otherwise, the user is not authenticated and denied access. Likewise, the user is not authenticated and denied access if the domain-affiliated application 55 is unable to retrieve the inner key from the location on the domain.

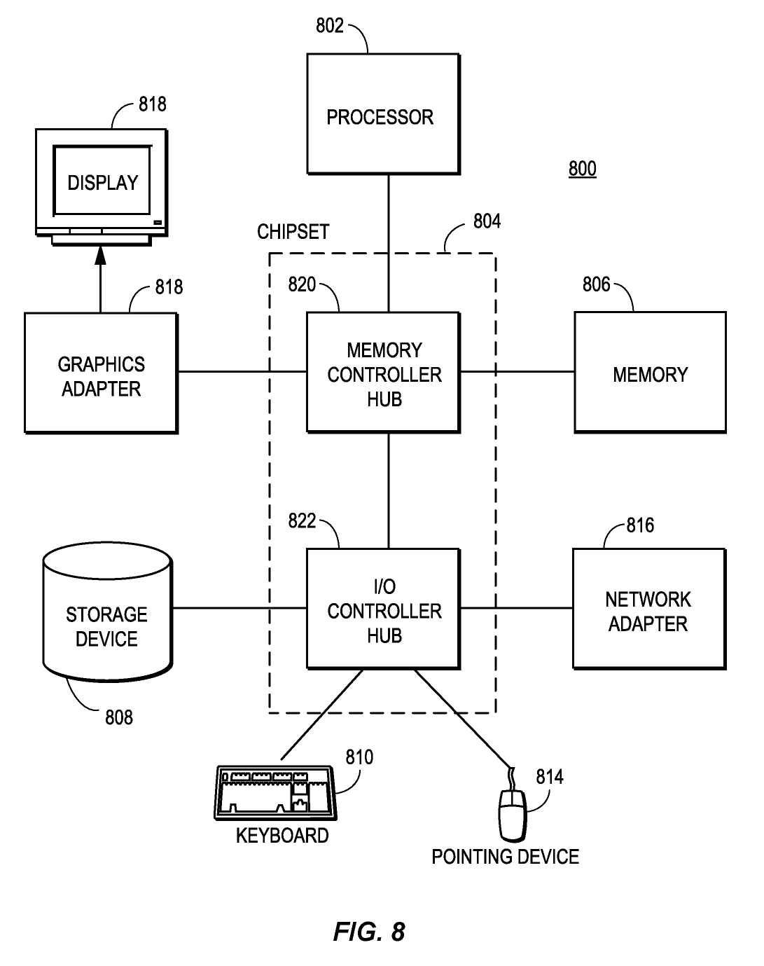

FIG. 8 is a high-level block diagram illustrating physical components of a computer 800 used as part or all of one or more of the entities described herein in one embodiment. For example, instances of the illustrated computer 800 may be used as the recipient 110, sender 120, and/or a node 140 in the domain 130. Illustrated are at least one processor 802 coupled to a chipset 804. Also coupled to the chipset 804 are a memory 806, a storage device 808, a keyboard 810, a graphics adapter 812, a pointing device 814, and a network adapter 816. A display 818 is coupled to the graphics adapter 812. In one embodiment, the functionality of the chipset 804 is provided by a memory controller hub 820 and an I/O controller hub 822. In another embodiment, the memory 806 is coupled directly to the processor 802 instead of the chipset 804. In one embodiment, one or more sound devices (e.g., a loudspeaker, audio driver, etc.) is coupled to chipset 804.

The storage device 808 is any non-transitory computer-readable storage medium, such as a hard drive, compact disk read-only memory (CD-ROM), DVD, or a solid-state memory device. The memory 806 holds instructions and data used by the processor 802. The pointing device 814 may be a mouse, track ball, or other type of pointing device, and is used in combination with the keyboard 810 to input data into the computer 800. The graphics adapter 812 displays images and other information on the display 818. The network adapter 816 couples the computer system 800 to a local or wide area network.

As is known in the art, a computer 800 can have different and/or other components than those shown in FIG. 8. In addition, the computer 800 can lack certain illustrated components. In one embodiment, a computer 800 acting as a node 140 may lack a keyboard 810, pointing device 814, graphics adapter 812, and/or display 818. Moreover, the storage device 808 can be local and/or remote from the computer 800 (such as embodied within a storage area network (SAN)).

As is known in the art, the computer 800 is adapted to execute computer program modules for providing functionality described herein. As used herein, the term “module” refers to computer program logic utilized to provide the specified functionality. Thus, a module can be implemented in hardware, firmware, and/or software. In one embodiment, program modules are stored on the storage device 808, loaded into the memory 806, and executed by the processor 802.

The above description is included to illustrate the operation of certain embodiments and is not meant to limit the scope of the invention. From the above discussion, many variations will be apparent to one skilled in the relevant art that would yet be encompassed by the spirit and scope of the invention.

What is claimed is:

1. A computer-implemented method of generating a domain identifier (ID) identifying a user to a computerized data storage domain, the method comprising:
generating an inner key and an outer key for the domain ID;
encrypting information about the user using the inner key to produce an encrypted inner core;
sending the inner key to the data storage domain, wherein the data storage domain stores the inner key at a location identified by a dead drop identifier (DDID);
receiving, from the data storage domain, the DDID identifying the location at which the inner key is stored;
generating an outer core comprising the DDID and the inner core;
encrypting the outer core using the outer key to produce the domain ID; and
storing the domain ID in a non-transitory computer-readable medium.

2. The computer-implemented method of claim 1, wherein generating an outer key comprises:
receiving a passphrase from the user; and
generating a symmetric encryption key using the passphrase as a seed.

3. The computer-implemented method of claim 1, wherein the data storage domain comprises a plurality of storage nodes connected by communication links and wherein the DDID references a storage location on one of the plurality of storage nodes.

4. The computer-implemented method of claim 1, further comprising storing the outer key within a password store.

5. The computer-implemented method of claim 1, wherein the information about the user comprises a set of tokens describing access rights of the user with respect to the data storage domain.

6. The computer-implemented method of claim 1, wherein the inner key and the outer key are symmetric encryption keys.

7. The computer-implemented method of claim 1, further comprising:
storing an activation record for the user at a node of the data storage domain, wherein information about the user includes a DDID for accessing the activation record.

8. A system for generating a domain identifier (ID) identifying a user to a computerized data storage domain, the system comprising:
a processor for executing computer program instructions; and
a non-transitory computer-readable storage medium storing computer program instructions executable by the processor to perform steps comprising:
generating an inner key and an outer key for the domain ID;
encrypting information about the user using the inner key to produce an encrypted inner core;
sending the inner key to the data storage domain, wherein the data storage domain stores the inner key at a location identified by a dead drop identifier (DDID);
receiving, from the data storage domain, the DDID identifying the location at which the inner key is stored;
generating an outer core comprising the DDID and the inner core;
encrypting the outer core using the outer key to produce the domain ID; and
storing the domain ID in a non-transitory computer-readable medium.

9. The system of claim 8, wherein generating an outer key comprises:
receiving a passphrase from the user; and
generating a symmetric encryption key using the passphrase as a seed.

10. The system of claim 8, wherein the data storage domain comprises a plurality of storage nodes connected by communication links and wherein the DDID references a storage location on one of the plurality of storage nodes.

11. The system of claim 8, the steps further comprising storing the outer key within a password store.

12. The system of claim 8, wherein the information about the user comprises a set of tokens describing access rights of the user with respect to the data storage domain.

13. The system of claim 8, wherein the inner key and the outer key are symmetric encryption keys.

14. The computer-implemented method of claim 1, further comprising:
storing an activation record for the user at a node of the data storage domain, wherein information about the user includes a DDID for accessing the activation record.

15. A non-transitory computer-readable storage medium storing computer program instructions executable by a processor to perform steps for generating a domain identifier (ID) identifying a user to a computerized data storage domain, the steps comprising:
generating an inner key and an outer key for the domain ID;
encrypting information about the user using the inner key to produce an encrypted inner core;
sending the inner key to the data storage domain, wherein the data storage domain stores the inner key at a location identified by a dead drop identifier (DDID);
receiving, from the data storage domain, the DDID identifying the location at which the inner key is stored;
generating an outer core comprising the DDID and the inner core;
encrypting the outer core using the outer key to produce the domain ID; and
storing the domain ID in a non-transitory computer-readable medium.

16. The non-transitory computer-readable storage medium of claim 15, wherein generating an outer key comprises:
receiving a passphrase from the user; and
generating a symmetric encryption key using the passphrase as a seed.

17. The non-transitory computer-readable storage medium of claim 15, wherein the data storage domain comprises a plurality of storage nodes connected by communication links and wherein the DDID references a storage location on one of the plurality of storage nodes.

18. The non-transitory computer-readable storage medium of claim 15, the steps further comprising storing the outer key within a password store.

19. The non-transitory computer-readable storage medium of claim 15, wherein the information about the user comprises a set of tokens describing access rights of the user with respect to the data storage domain.

20. The computer-implemented method of claim 1, further comprising:
storing an activation record for the user at a node of the data storage domain, wherein information about the user includes a DDID for accessing the activation record.
